(19) United States
(12) Patent Application Publication
(10) Pub. No.: US 2025/0272604 A1
(43) Pub. Date: Aug. 28, 2025

(54) MACHINE LEARNING MODEL BASED ARCHITECTURE FOR QUERY SERVICES

(71) Applicant: ADP, Inc., Roseland, NJ (US)

(72) Inventors: Roberto Coutinho, Porto Alegre (BR); Roberto Silveira, Roseland, NJ (US); Guilherme Gomes, Porto Alegre (BR); Carlos Nascimento, Porto Alegre (BR); Juliano Vacaro, Porto Alegre (BR)

(73) Assignee: ADP, Inc., Roseland, NJ (US)

(21) Appl. No.: 18/586,248

(22) Filed: Feb. 23, 2024

(51) Int. Cl. G06N 20/00

(52) U.S. Cl. CPC G06N 20/00

(57) ABSTRACT

Technical solutions include an ML based multi-model architecture to generate responses to enterprise employee queries. A processor can receive a query on a topic and identify ML models for a plurality of domains, trained using texts on a respective domain of the plurality of domains for each respective ML model and covering a plurality of topics corresponding geographic areas. The processor can select, using a first portion of the query and a classification model trained to classify the ML models according to the topics, a first ML model trained on a domain associated with the topic of the query. The processor can generate, using a second portion of the query corresponding to a geographic area of the geographic areas and the first ML model, a response to the query and provide the response.

### INTRODUCTION

This disclosure relates to computing technology, and more particularly to machine learning (ML) model-based query services.

### BACKGROUND

Organizations, including corporations and companies, can provide diverse services to users, such as customers or enterprise staff, using a variety of applications. These applications can incorporate ML models in their functionality. ML models can however face quality challenges, including concept drifts, hallucinations, and issues like data overfitting or underfitting. These challenges, if not addressed, can lead to inaccuracies in outputs, potentially causing computational or resource inefficiencies, or inaccurate responses that may harm to the end user or the enterprise.

### SUMMARY

Aspects of technical solutions described herein relate to a computing architecture in which a classification ML model selects, from a range of ML models trained on various domains of issues, an ML model that is configured to address an incoming query on a particular issue, such as a query from an employee on a human resources (HR) issue. Responding to queries, such as queries from enterprise employees across diverse geographical areas, each of which can be subject to specific employment laws, can pose challenges in terms of reliability, accuracy, and computing resource efficiency. Updating ML models to address the continuously evolving employment-related topics can be time, resource and energy intensive. Moreover, as domains of issues that the user queries can raise can be numerous and diverse, the ML models can face quality-related challenges, such as concept drifting, hallucinations, and data overfitting or underfitting. To address these challenges, the technical solutions provide an architecture that uses a classifier ML model to select an appropriate ML model from a pool of ML models trained for various domains of topics, thereby streamlining deployment and efficient retraining, while also reducing the occurrence of the ML model quality-related issues.

Some aspects of the technical solutions described herein relate to a system. The system can include one or more processors coupled with memory to receive a query on a topic. The system can include the one or more processors to identify a plurality of ML models for a plurality of domains. Each of the plurality of ML models can be trained using at least a plurality of texts on a respective domain of the plurality of domains for the respective ML model. Each respective domain of the plurality of domains can cover a plurality of topics for one or more geographic areas. The system can include the one or more processors to select, using at least a first portion of the query and a classification machine learning model trained to classify the plurality of the ML models according to the topics of the plurality of domains, a first ML model of the plurality of ML models. The first ML model can be trained on a domain of the plurality of domains associated with the topic of the query. The system can include the one or more processors to generate, using at least a second portion of the query corresponding to a geographic area of the one or more geographic areas and the first ML model, a response to the query. The system can include the one or more processors to provide the response for display.

The system can include the one or more processors to select the second model using at least the first portion of the query input into the classification ML model. The first portion can be indicative of the topic of the domain. The system can include the one or more processors to generate the response to the query using at least the second portion of the query input into the second model. The second portion can be indicative of the geographic area.

The system can include the one or more processors to generate, using at least the first portion of the query input into a processing ML model trained using at least the plurality of texts on queries to produce a plurality of outputs indicative of the plurality of topics concerning employees of one or more enterprises. The system can include the one or more processors to select, using at least the output input into the classification model, the first ML model.

The system can include the one or more processors to identify, based at least on the query input into a first processing ML model trained using a textual content corresponding to a plurality of tones, a tone of a text of the query. The system can include the one or more processors to update, based at least on the tone of the text and the response input into a second processing ML model trained on a plurality of responses for the plurality of tones, the response according to the tone. The system can include the one or more processors to provide, for display, the response updated by the second processing ML model.

The system can include the one or more processors to select, using at least the first portion of the query and the classification ML model, a second ML model of the plurality of ML models corresponding to a second domain associated with the topic. The system can include the one or more processors to generate, using at least the second portion of the query input into the second ML model, a second response to the query based at least on the topic.

The system can include the one or more processors to generate a first score corresponding to a relation between the query and the domain and a second score corresponding to a second relation between the query and the second domain. The system can include the one or more processors to rank the first response and the second response according to the score. The system can include the one or more processors to provide the response for display responsive to the rank of the response.

The domain of the plurality of domains can correspond to at least one of one or more rules for one or more employees of one or more enterprises in one or more geographical areas of the plurality of geographical areas. The domain of the plurality of domains can correspond to at least one or more rules on taxation of employees of one or more enterprises within one or more geographical areas of the plurality of geographical areas. The system can include the one or more processors to domain of the plurality of domains corresponds to at least one or more laws or one or more rules on wages for employees of one or more enterprises within one or more geographical areas of the plurality of geographical areas. The system can include the one or more processors to the domain of the plurality of domains corresponds to at least one or more rules on benefits for employees of one or more enterprises within one or more geographical areas of the plurality of geographical areas.

Some aspects of the technical solutions described herein are directed to a method. The method can include receiving, by one or more processors coupled with memory, a query on a topic. The method can include identifying, by the one or more processors, a plurality of ML models for a plurality of domains. Each of the plurality of ML models can be trained using at least a plurality of texts on a respective domain of the plurality of domains for the respective ML model. Each respective domain of the plurality of domains can cover a plurality of topics for one or more geographic areas. The method can include selecting, by the one or more processors, using at least a first portion of the query and a first machine learning (ML) model trained to classify the plurality of the ML models according to the topics of the plurality of domains, a first ML model of the plurality of ML models. The first ML model can be trained on a domain of the plurality of domains associated with the topic of the query. The method can include generating, by the one or more processors, using at least a second portion of the query corresponding to a geographic area of the one or more geographic areas and the first ML model, a response to the query. The method can include providing, by the one or more processors, the response for display.

The method can include selecting, by the one or more processors, the first ML model using at least the first portion of the query input into the classification machine learning (ML) model. The first portion indicative of the topic of the domain. The method can include generating, by the one or more processors, the response to the query using at least the second portion of the query input into the first ML model. The second portion can be indicative of the geographic area.

The method can include generating, by the one or more processors, using at least the first portion of the query input into a processing ML model trained using at least the plurality of texts on queries to produce a plurality of outputs indicative of the plurality of topics corresponding to a plurality of queries, the output indicative of the topic. The method can include selecting, by the one or more processors, using at least the output indicative of the topic as an input into the classification ML model, the first ML model.

The method can include identifying, by the one or more processors, based at least on the query input into a first processing ML model trained using a textual content corresponding to a plurality of tones, a tone of a text of the query. The method can include updating, by the one or more processors, based at least on the tone of the text and the response input into a second processing ML model trained on a plurality of responses for the plurality of tones, the response according to the tone. The method can include providing, by the one or more processors, the response updated by the second processing ML model for display.

The method can include selecting, by the one or more processors, using at least the first portion of the query and the classification ML model, a second ML model of the plurality of ML models corresponding to a second domain associated with the topic. The method can include generating, by the one or more processors, using at least the second portion of the query input into the second ML model, a second response to the query based at least on the topic.

The method can include generating, by the one or more processors, a first score corresponding to a relation between the query and the domain and a second score corresponding to a second relation between the query and the second domain. The method can include ranking, by the one or more processors, the first response and the second response according to the score. The method can include providing, by the one or more processors, the response for display responsive to the rank of the response.

The domain of the plurality of domains can correspond to at least one of one or more rules for one or more employees of one or more enterprises in one or more geographical areas of the plurality of geographical areas. The domain of the plurality of domains can correspond to at least one or more rules on taxation of employees of one or more enterprises within one or more geographical areas of the plurality of geographical areas. The domain of the plurality of domains can correspond to at least one or more laws or one or more rules on wages for employees of one or more enterprises within one or more geographical areas of the plurality of geographical areas.

Some aspects of the technical solutions described herein relate to a non-transitory computer-readable media having processor readable instructions, such that, when executed, the processor readable instructions cause at least one processor to receive, from a device, a query on a topic. When executed, the instructions can cause the at least one processor to identify a plurality of ML models for a plurality of domains. Each of the plurality of ML models can be trained using at least a plurality of texts on a respective domain of the plurality of domains for the respective ML model. Each respective domain of the plurality of domains can cover a plurality of topics for one or more geographic areas. When executed, the instructions can cause the at least one processor to select, using at least a first portion of the query and a classification machine learning (ML) model trained to classify the plurality of the ML models according to the topics of the plurality of domains, a first ML model of the plurality of ML models. The first ML model can be trained on a domain of the plurality of domains associated with the topic of the query. When executed, the instructions can cause the at least one processor to generate, using at least a second portion of the query corresponding to a geographic area of the one or more geographic areas and the first ML model, a response to the query. When executed, the instructions can cause the at least one processor to send the response to the device.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system for using an ML based multi-model architecture to provide responses to queries on topics in a particular field or domain (e.g., human resource services of an enterprise).

FIG. 2 illustrates a block diagram of an example computing system for implementing the embodiments of the present solution.

FIG. 3 illustrates an example of an output of a user interface 120 for providing a response to a query on an HR topic involving minimum wage laws in a state.

FIG. 4 is an example output of a user interface for providing a response to a query on an HR topic pertaining to employment of minors in a theater.

FIG. 5 is an example output of a user interface 120 for providing a response to a query on a topic of a definition of an employee.

FIG. 6 is an example output of a user interface for providing a response using a sequence and an instruction.

FIG. 7 is a flow diagram illustrating an example method for using an ML based multi-model architecture to provide responses to queries on topics in a particular field or domain.

### DETAILED DESCRIPTION

Following below are more detailed descriptions of various concepts related to, and implementations of, methods, apparatuses, and systems of ML based architecture for providing responses to queries, such as queries on HR. The various concepts introduced above and discussed in greater detail below may be implemented in any of numerous ways.

Aspects of technical solutions described herein are directed to an ML based multi-model architecture for providing responses to domain specific queries, such as queries on HR services from client devices associated with account identifiers of enterprise employees. When providing responses to queries of enterprise employees from various geographical areas (e.g., countries, states, counties or cities), any of which can have own specific employment related laws, it can be challenging, as well as time consuming and resource demanding, to provide reliable and accurate responses. These challenges are further exacerbated as geographical laws or rules are updated over time, driving the demand to continuously update the tools used to provide the employee responses. However, updating the tools, such as ML models for providing employee responses, can be very time, resource and energy intensive. Moreover, when generative ML models are retrained to address a variety of diverse and changing employment related topics, quality related ML model issues, such as concept drifting, hallucinations, data overfitting or underfitting can occur. As a result, using ML to address HR employee issues in various geographical areas can be both time, energy and resource intensive as well as inadequate in terms of the response consistency and accuracy.

The technical solutions can overcome these challenges by providing an architecture in which a classifier ML model can be trained to select, from a plurality of ML models trained to address queries in a variety of domains, a pretrained ML model suitable to address an incoming query. The technical solutions can match the text of the query to a topic within a domain of topics in which the selected ML model is trained. As each of the plurality of ML models can be trained in their own respective domain of topics, the likelihood of concept drifting, hallucinations, overfitting or underfitting data is reduced, resulting in improved accuracy model performance. In addition, as any of the respective ML models can be trained individually, the energy efficiency and resources for such individual model retraining can be conserved, resulting in solutions that are less time consuming and more energy efficient. As a result, the multi-model architecture of the technical solutions can provide an improved ML-based query response performance, while also reducing time, resources and energy consumption when any of the ML models are retrained.

Usage of large language models (LLMs), such as generative pre-trained transformer (GPT) models, to generate conversational text can lead to quality related issues, such as producing incorrect or misleading content. Further errors, delays, latency, or wasted computing resource utilization can by introduced by computing systems that execute operations based on the incorrect or misleading content generated by the LLM. This can make it difficult to utilize ML models (e.g., GPT models) in computing applications in an accurate, consistent and reliable manner. ML model performance issues, such as hallucinations, drifting, data overfitting or underfitting can occur more often when a single model is trained to perform a variety of disparate tasks. Fine-tuning and coordinating a group of GPT models into a system having guardrails to avoid incorrect or misleading results can facilitate more reliable and consistent outcomes helping introduce ML models into the business domain, such as in HR services applications for various enterprises.

Some aspects of the technical solutions described herein provide a coordinated group of ML models trained within their respective domain of topics, and a classifier model for selecting the most suitable models to address incoming queries. The queries can be generated from client devices associated with account identifiers (e.g., user accounts), such as those corresponding to employees of an enterprise. The provided architecture facilitates providing domain specific generative outputs powered by ML models with different responsibilities, such as to generate reliable and accurate results that are suitable for input into computing applications. The technical solutions allow for in-house training of ML models in an architecture that utilizes pre-trained weights that can be retrained and updated for energy and time efficient ML model fine tuning. For instance, the technical solution can utilize any number of natural language processing (NLP) GPT models that can be pretrained using dataset corpora, such as laws and rules from the U.S. Department of Labor, or any country, state, county or town-level government legislations, employment related rules and guidelines, commentaries or texts. The NLP GPT models can be fine-tuned to execute word sequence generated using dataset corpora.

The technical solutions can utilize post-processing functionalities, including verification of the output content for coherence and accuracy. Post-processing functions can improve the output quality and prevent wrong answers from being displayed to the end user. Tone or sentiment of the user can be evaluated through tone or sentiment analysis that can be implemented via a ML model. Post-processing functions can provide content filtering to conform the output to the appropriate tone or sentiment prior to its output to end users.

The technical solutions can include notifications, such as disclaimers, which can be provided in a header or a footer of the response. These notifications can inform the end users of the dataset limitations, such as the date range of the dataset, informing the user to verify the accuracy of the information provided independently. The technical solutions can include prompt engineering functionalities that can utilize application programming interface (API) functions to integrate the ML models with each other or other functions. For example, API calls can be used to call or activate ML models for text summarization or rewriting, question and answer functionalities, language translations and other features that can be used by the solutions.

For instance, the technical solutions can include one or more classifier models for identifying the most suitable or appropriate NLP GPT model for a particular user query, from a plurality of group of NLP GPT models trained for a variety of domains of issues. Once a classifier ML model selects the most suitable ML model, it can trigger the selected model by providing input parameters such as the starting prompt, initiating the generation of output text. The generative ML models can include fine-tuned NLP models specialized in predicting the next words in a sequence within their respective domain of topics. These generative ML models can be refined through datasets sourced from web documents, including the U.S. Department of Labor and the U.S. Department of Treasury. The technical solutions can include supporting ML models that can include ML models for supporting the overall system performance, such as handling named entity recognition, providing response confidence scoring, ranking of various responses, response rewriting and summarization and tone detection.

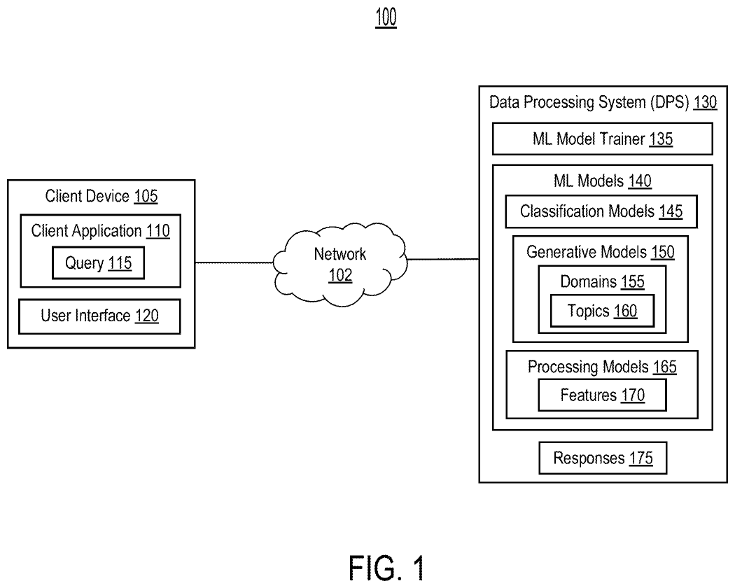

FIG. 1 depicts an example system 100 including an ML based multi-model architecture for providing responses to domain specific questions, such as enterprise employee HR queries. System 100 can include a client device 105 executing a client application 110, using which a user of the client device 105 can generate a query 115 via a user interface 120. Across a network 102, a data processing system (DPS) 130 can receive the query 115 and provide one or more responses 175 for the query 115. DPS 130 can include one or more ML model trainers 135 and one or more ML models 140. ML models 140 can include one or more classification models 145, processing models 165 and generative models 150. The generative models 150 can include or correspond to one or more domains 155 having or covering any number of topics 160 addressed by or corresponding to the query 115. The processing models 165 can address one or more features 170, such as tone, language, ranking or scoring that can pertain to either queries 115 or responses 175.

For example, a user can enter a query 115 (e.g., a question or an inquiry for a topic 160 within a specific domain 155) via a user interface 120 of a client application 110 executed on a client device 105. Query 115 can be transmitted, via a network 102 (e.g., the internet), to a DPS 130 that can be executed on a server, a cloud-based software as a service (SaaS) platform or a virtual machine. DPS 130 can be configured to provide responses 175 to various queries 115 using any number of ML models 140 trained by one or more ML model trainers 135. ML models 140 can include LLM models, such as NLP GPT models trained on a variety of topics 160 within various domains 155 (e.g., fields or issues) corresponding to one or more services, such as HR services provided to employees of one or more enterprises.

A processing model 165 can process the query 115 to identify features 170, such as the tone of the user or the language used. A classification model 145 can include a pretrained ML model to identify one or more topics 160 corresponding to the query 115 within specific one or more domains 155 corresponding to the one or more generative models 150 trained for those domains 155. A most suitable classification model 145 can be selected to use as its input at least a portion of the query 115 (e.g., text) to generate the response 175 for the query 115. A processing model 165 can then process the response 175 to adjust the wording of the response 175 based on any identified features 170, such as the tone or the language of the inquiry. When ML models 140 provide multiple responses 175, a processing model 165 can provide the ranking of the responses 175 (e.g., based on the confidence score or relevance of the selected generative model 150) and provide the response 175 to the client device 105 for display to the user (e.g., via the user interface 120) and any display hardware on the client device 105.

Client device 105 can include any combination of hardware and software for generating a query 115 for the DPS 130. Client device 105 can include any computing device communicating over a network 102 with DPS 130 and facilitating a user interaction with the DPS 130 via a client application 110 and a user interface 120. Client device 105 can include an account for a user. The account can include an account identifier by which the system 100 can identify the user sending the query 115. Client device 105 can include computing devices, such as a smartphone, tablet, or computer, and can provide the interface for the user to input queries 115 via a user interface 120 for the DPS 130 to address using one or more ML models 140. For instance, a client device 105 can include a laptop, on which a user can utilize a user interface 120 (e.g., a web browser) to access an online platform (e.g., DPS 130) that employs NLP models (e.g., ML models 140) to respond to text-based queries 115. For example, a user can use a mobile phone executing a dedicated client application 110 to interact with a DPS 130 and utilize ML models 140 to provide queries 115 and receive responses 175 via a user interface 120 on a display of the client device (e.g., the mobile display).

Client application 110 can include any application the user can utilize to communicate with a DPS 130. Client application 110 can include a web based application, a dedicated application for a DPS 130 or a virtual assistant that can receive and queries 115 from the client device 105 via a speaker (e.g., speaker of a smartphone), allowing the user to vocalize the queries 115. Client application 110 can include account identifiers of the users. Client application 110 can receive queries 115 via a text based input or a voice input (e.g., speech recognition) and can send the queries 115 via the network 102 to a DPS 130. Client application 110 can receive responses 175 from the DPS 130 and can present them back to the user, such as via a display on the user display or sound output (e.g., reading out of the response).

Query 115 can include any inquiry, request or input on a client device 105. Query 115 can include a user input, such as a question of a user, for a particular topic 160 within a particular domain 155 of topics. The user can be any user of an application or an ML model, such as a customer of an enterprise (e.g., a user of enterprise tools or services), an employee of the enterprise, a contractor or any other person that can have an account for an application or service. Query 115 can include a text input of a user, or a spoken input or command initiated by the user to trigger an action from the DPS 130 (e.g., a response 175 generated by the ML models 140). Query 115 can include a range of topics. For instance, in the context of HR services, query 115 can include a question for information on wages, asking how overtime payments are calculated or inquiring about the current minimum wage in a given state or country. In terms of employee benefits, a query 115 can inquire about available health insurance options or details regarding retirement plans. Queries 115 can include or correspond to enterprise policies by asking about vacation days, remote work policies, or procedures for reporting workplace harassment. Queries 115 can include tax-related questions, such as information on the deduction process from employee salaries or inquiring about potential tax benefits. Queries 115 can include compliance questions focusing on legal concerns for employee termination or how the company adheres to labor laws. Queries 115 can correspond to professional development by asking about training opportunities, skill development initiatives, or understanding how the company supports career growth. This variety of examples showcases the diverse nature of queries users might pose regarding HR issues across a variety of geographical areas (e.g., countries, states, counties or towns).

User interface 120 can include any combination of hardware and software for providing a user with a means to interface with the system 100. User interface 120 can include a point of interaction between a user and a computing system 200. User interface 120 can facilitate users' communication with and control of the system, providing features for user input (e.g., prompts or voice inputs) and providing output windows (e.g., to display or sound the responses 175), allowing the user to communicate with the DPS 130 and use the ML models 140. User interface 120 can include, for example, graphical elements, such as buttons, menus, icons, and forms, as well as interactive components such as sliders, checkboxes, and input fields. User interface 120 can vary across different platforms, applications, and devices, ranging from desktop software to web applications and mobile apps.

Network 102 can include any communication medium facilitating interaction between client devices 105 and data processing systems 130. Network 102 can include various forms, such as the Internet, including a global system of connecting devices worldwide. Network 102 can include cellular networks, enabling connectivity through mobile devices, or private networks of organizations, local area network (LANs), wireless LANs (WLANs), or virtual private networks (VPNs) that can be used to provide secure channels for communication. Network 102 can include one or more specific geographic locations or interconnected devices in an open or a closed environment.

Data processing system 130 can include any combination of hardware and software for receiving queries 115 and utilizing ML models 140 to provide responses 175. DPS 130 can be executed on servers, virtual machines, or cloud infrastructure. DPS 130 can include or utilize ML model trainers 135 for training or updating ML models 140, including classification models 145, generative models 150 and processing models 165. Upon receiving a query 115 from the client device 105, the DPS 130 can utilize a parsing function (e.g., a parser) to parse or split the query 115 into any number of parts or portions. DPS 130 can identify the content or context of the individual portions, such as for example a first portion of the query corresponding to a particular domain 155 to which the inquiry is directed or a second portion of the query identifying a topic 160 within the given domain 155.

DPS 130 can utilize classification models to analyze and understand the nature of the query 115, including topics 160 within one or more domains 155. DPS 130 can use classification models 145 to determine the topic, context or category of the query 115 and select the most appropriate generative model 150 trained on that particular topic 160 within a particular domain 155 for generating the most relevant response 175. DPS 130 can utilize processing models 165 to identify features 170 and adjust the responses 175 (e.g., or the queries 115).

For example, a DPS 130 can receive a query 115 for a particular HR-related topic 160 within a domain 155. DPS 130 can use API calls to trigger the classification model 145 to categorize the query 115 as a query for a particular topic 160 (e.g., minimum wage in a particular state), and identify or select a fine-tuned NLP GPT model trained in addressing that particular domain of topics 160. Once the selected generative model 150 provides a response 175, the DPS 130 can send one or more API calls to trigger one or more processing models 165 to modify the response 175 according to one or more features 170, such as scoring or ranking for a plurality of responses 175 provided to a single query 115 or adjusting the tone of the response 175 prior to sending the response to the client device 105.

ML model trainer 135 can include any combination of hardware and software for training ML models 140. ML model trainer 135 can include any computer code, commands, data (e.g., corpora or textual data) for training or retraining machine learning models (e.g., 145, 150, 165). In the context of classification models 145, ML model trainer 135 can utilize various textual inputs and labels to train selection or recognition of the most suitable generative models 150 for addressing specific queries 115 within one or more domains 155. For instance, ML model trainer 135 can train a classification model 145 to utilize a similarity search (e.g., cosine similarity or Euclidean distance) to find a topic 160 within a domain 155 most similar to the query 115. For example, ML model trainer 135 can train a classification model 145 to use sequence generation to identify the domain 155 of a particular generative model 150. ML model trainer 135 can be designed to handle various types of ML models, including NLP models like GPT (Generative Pre-trained Transformer) or other alternatives.

During the training process, the ML model trainer 135 can use labeled datasets specific to the domain of interest. For example, in the context of HR-related queries 115 and generative models 150, the ML model trainer 135 can use a dataset comprising labeled examples of HR queries 115 and corresponding correct responses 175. ML model trainer 135 can train models 140 by adjusting various weights and parameters of the models to minimize the difference between the predicted outputs and the actual labels in the training data. For instance, in a scenario involving a GPT model fine-tuned for HR-related queries 115, the ML model trainer 135 can adjust the weights of the classification model 145 that identifies the domain 155 or topic 160 for a given query 115. Once this classification model 145 determines the HR domain 155, the model can trigger the selection of the most suitable generative model 150, such as the fine-tuned GPT model for HR issues. Adjustments to the weights can include updating the weights iteratively based on the model's performance on the training dataset. Techniques like backpropagation and gradient descent can be used to minimize the error or loss function to facilitate model generalization of unseen data and can accurately categorize queries into the appropriate domain.

ML models 140 can include any machine learning or artificial intelligence models for providing responses 175 for queries 115. An ML model 140 can include any computational algorithm or statistical model designed to enable a system to learn from data, make predictions, or perform tasks without being explicitly programmed to perform the specific task. ML models 140 can include any number or combination of classification models 145, generative models 150 or processing models 165. Classification models 145 can be configured or designed to categorize input data into predefined classes or categories, facilitating identification of the most suitable generative models 150 to address the incoming query 115. Generative models 150 can include, for example, generative adversarial networks (GANs) or transformer-based architectures and be configured to generate new instances of data based on patterns learned during training. Processing models 165 can include LLMs that can be trained to detect tones or user sentiment and facilitate modifications to the responses 175 to be provided in accordance with the tones or sentiment of the user. ML model trainer 135 can train and optimize any of the ML models 140, such as by adjusting their weights and parameters for particular types or classes of data in order to improve the performance of the models over time. ML models 140 can formulate or provide the ML modeling portion of the architecture of the system 100 in which ML models 140 work collaboratively to handle user queries 115, with classifiers selecting the generative models and processing models 165 to respond appropriately.

Classification models 145 can include any ML model 140 for categorizing incoming queries 115 and identifying the most suitable generative model 150 for addressing each query 115. Classification model 145 can include the functionality to detect, determine or recognize the domain 155 of a particular generative model 150 based on a topic 160 most closely resembling or corresponding to the text of at least a portion of the query 115. Classification model 145 can sort queries 115 into categories, allowing for a more targeted response. For instance, a classification model 145 can discern whether a query pertains to finance, healthcare, or technology. The selection of the generative model 150 to address the query 115 can be based at least upon this classification. Classification model 145 can include, for example, Support Vector Machines (SVM), Random Forests, or neural networks with SoftMax activation for multi-class categorization. Classification model 145 can be trained on labeled datasets, allowing the classification model 145 to learn patterns and associations between queries 115 and the domains 155 of the corresponding generative models 150. As a result, when a user enters a query 115, the classification model 145 can determine the domain 155 that most closely relates to the query 115 (e.g., when the domain 155 includes a topic 160 most closely aligning with the query 115). This, in turn, can guide the subsequent selection of a specialized ML models such as a type of the model (e.g., specific generative model 150), including any NLP or generative model that can be most suitable to provide the most accurate response 175.

Generative models 150 can include any ML or AI model for receiving for generating a response 175 based at least on a portion of the query 115 (e.g., a portion of a text of the query 115) input into the model 150. Generative model 150 can include a generative model, an NLP model, a transformer based model, an LLM or any other type and form of ML model 140. Generative ML model 150 can include a GPT designed (e.g., trained) to address queries 115 across a range of topics 160 within a specific domain 155, such as questions topics of overtime wages in the domain of wage rules. Generative models 150 can be trained on extensive datasets to understand the complexities of human language and generate contextually relevant responses. Generative models 150 can include GPT using transformer-based architectures to capture long-range dependencies in sequential data, to be utilized for natural language understanding and generation. Using the queries 115 as input, generative models can generate coherent and contextually appropriate responses 175.

Domains 155 can include any field or range of topics 160 pertaining to user queries 115. Domain 155 can include specific areas or topics of focus that the ML models can be trained by the ML trainer 135 to comprehend and respond to effectively. For instance, in the applications for human resources (HR) issues, domains 155 can cover a range of topics 160 on employment benefits, wages, minor employee issues, and employer or employee taxation matters. Each such domain 155 can correspond to distinct aspects of HR management, such as determining and managing employee benefits packages, handling wage-related inquiries, addressing minor employee concerns, and navigating the complexities of taxation for both employers and employees. Furthermore, the geographical scope can add additional layer of specificity, considering that employment laws, regulations, and practices can vary significantly across different geographical regions, such as countries, states, counties, and towns. A generative model 150 trained to address HR queries within a specific domain 155 can include the knowledge and adaptability to provide accurate and contextually relevant responses 175 tailored to the queries 115 within each topic 160 of the given domain 155, across any geographic regions.

Topics 160 can include any subjects or issues within a particular domain, including enterprise employment topics, topics on HR or payroll services, such as topics on employment wages, topics on taxation of enterprise or employees, employee benefits topics, topics on enterprise organization or any other topics concerning employees and enterprises. Topics 160 can include any information on payroll services related topics, such as information on processing of employee wages and salaries, deduction of taxes or withholdings, generation of paychecks of direct deposits, preparing or facilitating tax filings, implementing compliance with local, state or federal tax regulations, implementing actions in compliance with local labor laws, handling of tax forms (e.g., W-2, 1099 and other forms), management of employee benefits (e.g., health insurance, retirement plans), time and attendance tracking (e.g., counting employee work hours) and tracking of employee leave, vacation or sick days, handling payroll deductions,

Topics 160 can include or cover any information or details relevant to any number of issues a person can face within a given domain 155. Topics 160 can include inquiries about details or specific examples relating to health insurance coverage, retirement plans, paid time off policies, or employee assistance programs. For wages, topics 160 can include salary structures, overtime calculations, pay frequency, or bonus distribution. Topics 160 can include concerns related to workplace dynamics, interpersonal conflicts, or company policies. In the domain of employer or employee taxation, topics 160 can involve queries about tax deductions, withholding procedures, or compliance with local tax regulations in specific geographical areas, such as countries, states, counties, or towns. For instance, an example topic 160 within the taxation domain 155 could be an inquiry about the tax implications of remote work in a particular state or the tax treatment of employee stock options.

Processing models 165 can include any ML or AI models for processing or updating queries 115 or responses 175. Processing models 165 can identify or address various features 170, such as tone of the language used in a query 115, language of the query 115, score (e.g., a confidence score) for a given response 175 or ranking for a given response 175 of a plurality of responses 175 generated for a single query 115. For example, when determining the tone of a query 115, processing model 165 can include a sentiment analysis model for detecting the tone (e.g., angst or impatience) of a user, allowing the processing model 165 to modify or tailor the response 175 generated by a generative model 150 to provide the answer in a calm and understanding tone. Processing model 165 can include an LLM trained to provide a summary or a paraphrased version of a response 175 or a query 115.

Processing models 165 can include translation models to convert converting queries 115 into different languages or dialects as desired, facilitating a broader reach and accessibility. For instance, a language translation processing model 165 can translate a portion of a response into a particular language, based on the query 115. For example, a scoring processing model 165 can include the functionality to generate a score, based on criteria such as confidence, relevance, or sentiment scores. These scores can provide a quantitative measure of the model's certainty or appropriateness in generating a particular response 175. For instance, a score 305 of 0.95 can indicate a 95% confidence that the most relevant model was used for the response, a 95% confidence that the response is accurate, or a 95% similarity between the topic 160 of a domain 155 of the selected generative model 150 and the query 115. When multiple responses are generated, a ranking processing model 165 can use scores generated for various responses 175 to order or prioritize responses 175, presenting the user with the most relevant or confident answer first. Accordingly, processing models 165 can improve the adaptability and effectiveness of the multi-model architecture by discerning the tone, facilitating multilingual communication, and providing nuanced scoring and ranking of various responses 175.

Features 170 can correspond to various features within queries 115 and responses 175 to improve and provide nuance to the user responses 175. Features 170 can include the tone conveyed in queries 115 which can be detected through sentiment analysis, facilitating tailored responses based on user tone or sentiment, whether it be calming, understanding, or informative. Additionally, features 170 can include the language or dialect of the query 115, providing model support for language translation. Features 170 can include scores provided by scoring models which can work in conjunction with generative models 150 to determine the confidence with which a particular response 175 is generated (e.g., confidence scores), relevance to the query 115 (e.g., relevance scores) or sentiment scores, thereby facilitating a quantitative measure of the system's certainty or appropriateness. Features 170 can include ranking for various responses 175, such as when a ranking model prioritizes multiple responses 175 generated by multiple selected generative models 150, presenting the most pertinent or confident answer first (e.g., presenting answers in the order of the score, with the highest score first). Identifying and providing such features 170 can improve the adaptability and effectiveness of the multi-model architecture.

Responses 175 can include any responses by the DPS 130 responsive to the queries 115. Responses 175 can be generated by any combination of one or more generative models 150 or processing models 165. Leveraging the capabilities of generative models 150 such as GPT, responses 175 can be crafted to be informative and contextually relevant across a spectrum of topics 160 within specific domains 155. Processing models 165 can refine these responses 175 by considering features such as tone, sentiment, and language, ensuring that the generated content aligns with the user's emotional tone and language preferences. Responses 175 can be provided to the client device 105, via a network 102, for display via a client device 105 or sounding via client device's sound system.

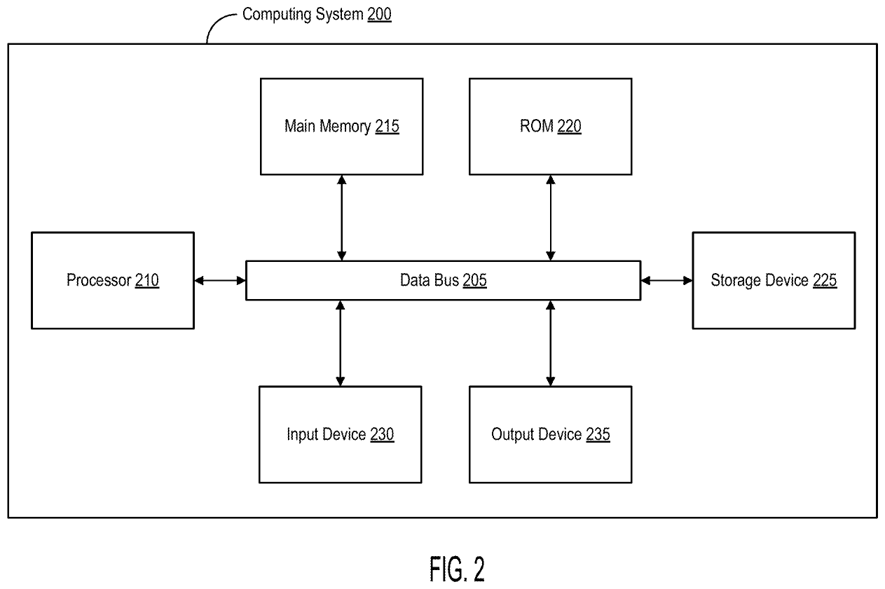

FIG. 2 illustrates a block diagram of a computing system 200 for implementing the embodiments of the present solution, in accordance with embodiments. FIG. 2 illustrates a block diagram of an example computing system 200, which can also be referred to as the computer system 200. Computing system 200 can be used to implement elements of the systems and methods described and illustrated herein, such as for example, commands, instructions or data described herein. Computing system 200 can be included in, provide support for, or run any device (e.g., client or a user device 105, DPS 130), or any other feature or component described herein.

Computing system 200 can include at least one bus data bus 205 or other communication device, structure or component for communicating information or data. Computing system 200 can include at least one processor 210 or processing circuit coupled to the data bus 205 for executing instructions or processing data or information. Computing system 200 can include one or more processors 210 or processing circuits coupled to the data bus 205 for exchanging or processing data or information along with other computing systems 200. Computing system 200 can include one or more main memories 215, such as a random access memory (RAM), dynamic RAM (DRAM), cache memory or other dynamic storage device, which can be coupled to the data bus 205 for storing information, data and instructions to be executed by the processor(s) 210. Main memory 215 can be used for storing information (e.g., data, computer code, commands or instructions) during execution of instructions by the processor(s) 210.

Computing system 200 can include one or more read only memories (ROMs) 220 or other static storage device 225 coupled to the bus 205 for storing static information and instructions for the processor(s) 210. Storage devices 225 can include any storage device, such as a solid state device, magnetic disk or optical disk, which can be coupled to the data bus 205 to persistently store information and instructions.

Computing system 200 may be coupled via the data bus 205 to one or more output devices 235, such as speakers or displays (e.g., liquid crystal display or active matrix display) for displaying or providing information to a user. Input devices 230, such as keyboards, touch screens or voice interfaces, can be coupled to the data bus 205 for communicating information and commands to the processor(s) 210. Input device 230 can include, for example, a touch screen display (e.g., output device 235). Input device 230 can include a cursor control, such as a mouse, a trackball, or cursor direction keys, for communicating direction information and command selections to the processor(s) 210 for controlling cursor movement on a display.

The processes, systems and methods described herein can be implemented by the computing system 200 in response to the processor 210 executing an arrangement of instructions provided via main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors 210 in a multi-processing arrangement may also be employed to execute the instructions contained in main memory 215. Hard-wired circuitry can be used in place of or in combination with software instructions together with the systems and methods described herein. Systems and methods described herein are not limited to any specific combination of hardware circuitry and software.

Although an example computing system has been described in FIG. 2, the subject matter including the operations described in this specification can be implemented in other types of digital electronic circuitry, or in computer software, firmware, or hardware, including the structures disclosed in this specification and their structural equivalents, or in combinations of one or more of them.

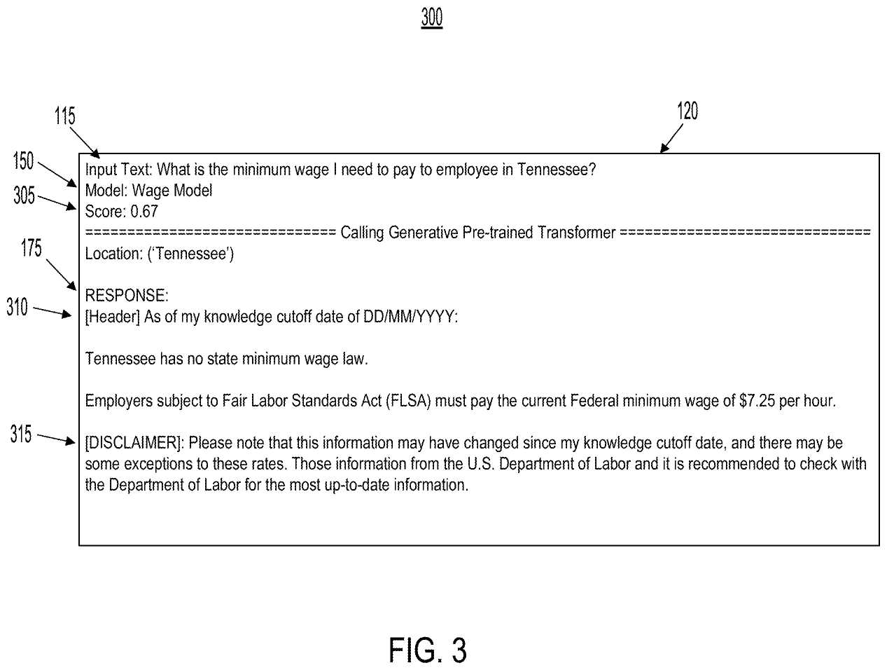

FIG. 3 illustrates an example of an output 300 of a user interface 120 for providing a response 175 to a query 115 on an HR issue (e.g., minimum wage laws in Tennessee). The example output 300 can include or correspond to a screenshot of a user interface 120 presenting the response 175 and the text of a query 115 on the client device 105. The example output 300 can identify a generative model 150 used for generating the response 175 and a score 305 for the response. For instance, the query 115 can correspond to a question of a user about a minimum wage in the state of Tennessee, whereas the response 175 can provide information on the Tennessee minimum wage laws and federal laws that may be applicable. The score 305 can indicate, for example, a level of confidence (e.g., confidence score) corresponding to the likelihood or confidence in the accuracy of the response 175, likelihood or confidence that the correct generative model 150 was utilized. Response 175 can include a header 310 that can include or identify limitations to the response, such as a date limitation for the data on which the generative model 150 was trained (e.g., data range at which the information used for training has ended). Response 175 can include a disclaimer 315 that can identify possible exceptions or alternatives to the answer, sources of the information used for generating the response 175 and instructions to independently verify the response.

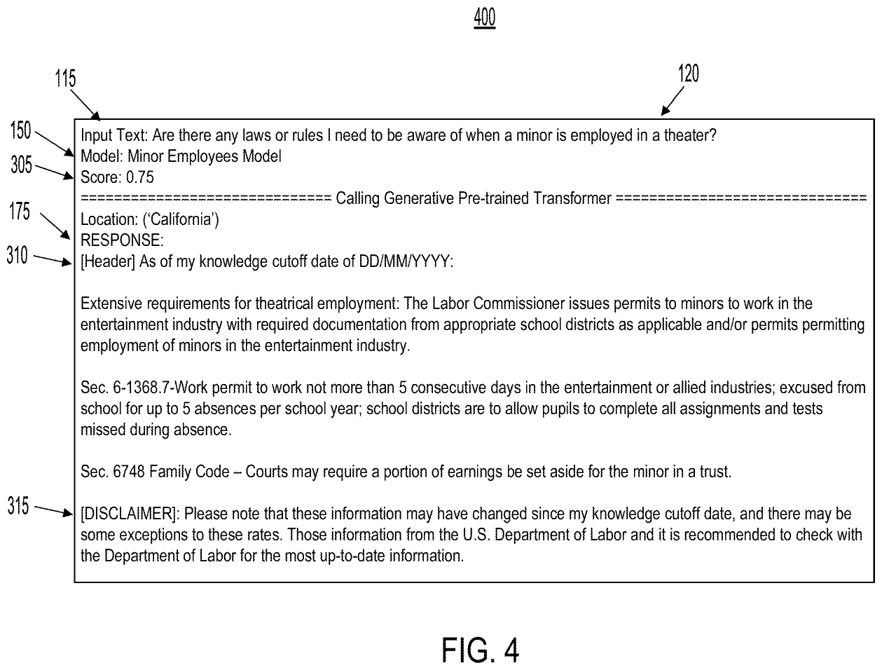

FIG. 4 is an example 400 of another output of a user interface 120 for providing a response 175 to a query 115 on an HR issue (e.g., employment of minors in a theater). Example output 400 can include the response 175 and the text of a query 115 displayed on the client device 105, identifying a generative model 150 (e.g., minor employees' model) used for generating the response 175 and a score 305 (e.g., 0.75) for the response. The query 115 can correspond to a question of a user about the laws when employing a minor in a theater. The response 175 can provide information on the theatrical employment of minors from the selected generative model 150 (e.g., the minor employees model). The score 305 can indicate the confidence level of the response, whereas the header 310 can identify limitations to the response, such as a cutoff date for the data on which the generative model 150 was trained. As with example output 300, disclaimer 315 can identify exceptions or alternatives to the answer, sources of the information used for generating the response 175 and instructions to independently verify the response.

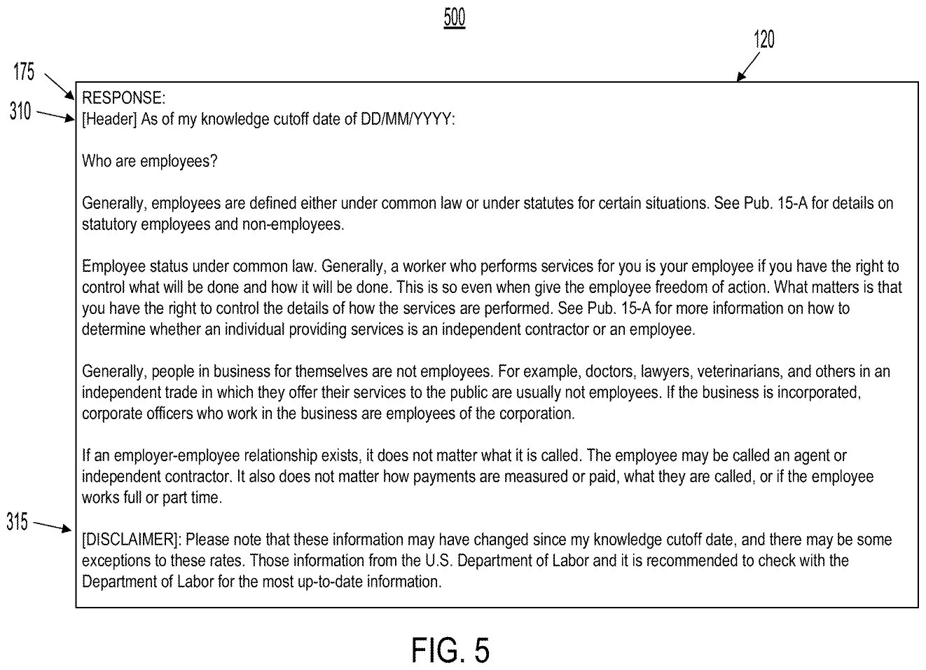

FIG. 5 is an example output 500 of a user interface 120 for providing a response 175 to a query 115 on an issue of employee definition. The example output 500 can include the response 175 describing a definition of an employee under a common law and providing sources. The response 175 can include a header 310 identifying limitations of the response (e.g., the cutoff date for the training data) and a disclaimer 315 identifying exceptions or alternatives to the answer, sources of the information used for generating the response 175 and instructions to independently verify the response.

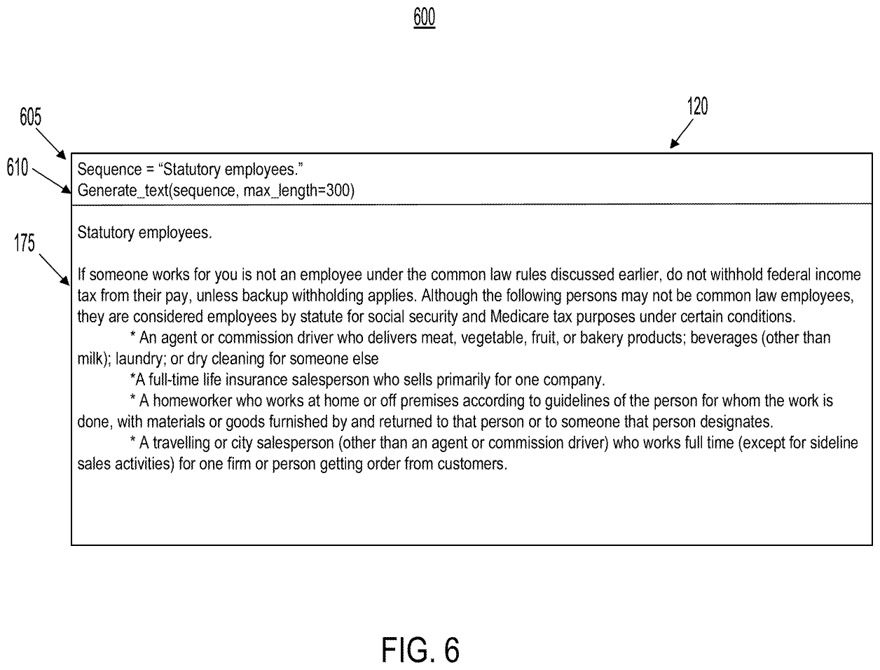

FIG. 6 is an example output 600 of a user interface 120 for providing a response 175 using a sequence 605 and an instruction 610. The example output 600 can include the response 175 generated using a sequence 605 of a string of characters (e.g., “statutory employees”) based on which the ML models 140 can generate the response 175. The instruction 610 can include commands to identify the sequence 605 and a size length of the response 175. For instance, instruction 610 can include “max_length” command indicating a maximum length of the response 175 to, for example, 300 characters. Using the sequence 605, the system 100 can generate the response 175 via one or more ML models 140 and provide the sequence 605 and the instructions 610 in the output of the user interface 120 to be displayed on the client device 105. For instance, a sequence 605 or instruction 610 can be generated or output by a processing model 165, which can then be input into a generative model 150 selected to utilize the sequence 605 or instruction 610 output by the processing model 165, to generate a response 175.

In an example, system 100 can include one or more processors 210 coupled with memory 215. For instance, system 100 can include at least one processor 210 and a non-transitory computer-readable media (e.g., memory 215 or storage 225) having or storing processor readable instructions. The instructions can include commands or data that can be executed by the at least one processor 210, such that, when executed by the at least one processor 210, the processor readable instructions cause at least one processor 210 to receive a query 115 on a topic 160. For instance, the at least one processor 210 can receive a query 115 corresponding to, related to or otherwise sharing a common language or meaning with a topic 160 within a domain 155. The query 115 can be entered by a user (e.g., account identifier of an application 110 or a client device 105 identifying a user) via a user interface 120 of a client application 110 executed on a client device. The query 115 can be received by the DPS 130, via a network 102, e.g., the Internet.

The at least one more processor 210 can identify a plurality of ML models 140, such as generative models 150, trained or configured for a plurality of domains 155. Each of the plurality of ML models 140, for example, can be trained using at least a plurality of texts on a respective domain 155 of the plurality of domains 155 for the respective ML model 140. Each respective domain 155 of the plurality of domains 155 can cover a plurality of topics 160 on a payroll (e.g., HR issues) for one or more geographic areas (e.g., multinational regions, countries, states, counties or municipalities).

The at least one processor 210 can select, using at least a first portion of the query 115 and a first or a classification machine learning (ML) model (e.g., classification model 145) trained to classify the plurality of the ML models (e.g., generative models 150) according to the topics 160 of the plurality of domains 155, a second ML model (e.g., a particular generative model 150) of the plurality of ML models (e.g., plurality of generative models 150). For example, the at least one processor 210 can be configured (e.g., via instructions executed from the memory 215, ROM 220 or storage 225) to execute a classification model 145 to identify a particular generative model 150 trained on a domain 155 that includes a particular topic 160 that most closely resembles the text of the query 115. For example, the classification model 145 can utilize a similarity search (e.g., cosine similarity) to identify the topic 160 of a plurality of topics 160 from a domain 155 of a plurality of domains 155 corresponding to a plurality of generative models 150 that most closely relates to the contents of the query 115. The second ML model (e.g., the selected generative model 150) can be trained on a domain 155 of the plurality of domains 155 associated with the topic 160 of the query 115 (e.g., the topic 160 most closely matching or resembling the query 115).

The at least one processor 210 can generate, using at least a second portion of the query 115 corresponding to a geographic area of the one or more geographic areas and the second ML model (e.g., 150), a response 175 to the query 115. For example, the at least one processor 210 can generate the response 175 by inputting the query 115 into the selected generative model 150. For example, the at least one processor 210 can generate the response 175 by inputting an output from a processing model 165 into the generative model 150. The output from the processing model 165 can include, for example, a modified, refined or clarified text of the query 115.

The at least one processor 210 can provide the response 175 for display. For instance, the at least one processor 210 can provide the response 175 to a client device 105 to be displayed using a user interface 120. The at least one processor 210 can process, modify or change the response 175 using one or more processing models 165 prior to sending the modified or updated response 175 to the client device 105. For example, a processing model 165 trained to adjust or modify the response 175 for tone, can rewrite the response to accommodate or respond to a tone of the user query 115. For instance, the processing model 165 can draft the response 175 to express understanding and empathy when the tone of the query 115 associated with an account identifier of the user was detected by a processing model 165 detecting tone to have a tone or language expressing irritation or anxiousness.

The at least one processor 210 can select the second model (e.g., selected generated model 150) using at least the first portion of the query 115 (e.g., one or more words or phrases corresponding to issue inquired by the user) input into the first machine learning (ML) model (e.g., classification model 145). The first portion of the query 115 can be indicative of the topic 160 of the domain 155. For example, the first portion of the query 115 can include words or phrases that specify a topic 160 inquired about by the user, such as wording indicative of underage employees, employment in particular fields or facilities, rules or laws involving wages, employee benefits, employment contracts, employee guidelines, safety or security measures or protocols, manufacturing or processing guidelines or processes, payment processing, taxation of enterprises or employees, human resource services, or any other topic or issue involving payroll. The at least one processor 210 can generate the response 175 to the query 115 using at least the second portion of the query 115 input into the second model (e.g., selected generative model 150). The second portion of the query 115 can be indicative of the geographic area (e.g., a state, a region, a country, a municipality or any other geographical area).

The at least one processor 210 can generate, using at least the first portion of the query 115 input into a third model trained using at least the plurality of texts on queries to produce a plurality of outputs indicative of the plurality of topics 160 corresponding to a plurality of queries 115, the output indicative of the topic 160. The third model can include a processing model 165 trained to rephrase the query 115 in order to clarify the issue or topic 160 investigated. The output can include an updated or clarified issue or question from the query 115. The at least one processor 210 can select, using at least the output input into the first ML model (e.g., classification model 145), the second ML model (e.g., the selected generative model 150 to be used for processing the query 115 and providing response 175).

The at least one processor 210 can identify, based at least on the query 115 input into a fourth ML model (e.g., processing model 165) trained using a textual content corresponding to a plurality of tones, a tone of a text of the query 115. The fourth ML model can include a sentiment processing model 165 trained to detect tone or sentiment of the user. The at least one processor 210 can update, based at least on the detected or identified tone of the text and the response 175 generated by the second ML model (e.g., 150) input into a fifth ML model (e.g., another processing model 165) trained on a plurality of responses for the plurality of tones, the response 175 according to the tone. For example, once a selected generative model 150 generates the response 175, a processing model 165 configured to rewrite the response 175 according to a tone can update or modify the response 175 in accordance with a particular tone, prior to providing the response 175 to the client device. The at least one processor 210 can provide, for display, the response 175 updated by the fifth ML model (e.g., 165).

The at least one processor 210 can select, using at least the first portion of the query 115 and the first ML model (e.g., classification model 145), a third ML model (e.g., another generative model 150) of the plurality of ML models 150. The third ML model can correspond to a second domain 155 associated with the topic 160. For example, the third ML model can share a topic 160 with the second ML model in a different domain 155, as the two domains 155 can partly overlap or be related to each other. The third ML model (e.g., second selected generative model 150) can generate, using at least the second portion of the query input into the third ML model, a second response 175 to the query 115 based at least on the topic 160. The topic 160 can be a topic of the second domain 155 of the third ML model and can be similar to, overlapping with or related to the topic 160 of the domain 155 of the second ML model.

The at least one processor 210 can generate a first score 305 corresponding to a relation between the query 115 and the domain 155 and a second score 305 corresponding to a second relation between the query 115 and the second domain 155. For example, the first score 305 can indicate the similarity between query 115 and the topic 160 of the domain 155 of the second ML model (e.g., the first selected generative model 150). For example, the second score 305 can indicate the similarity between query 115 and the topic 160 of the domain 155 of the third ML model (e.g., the second selected generative model 150). The at least one processor 210 can rank the first response 175 and the second response 175 according to the first score 305 and the second score 305. The at least one processor 210 can provide the response 175 for display responsive to the rank of the response.

The domain 155 of the plurality of domains can correspond to at least one of one or more rules for one or more employees of one or more enterprises in one or more geographical areas of the plurality of geographical areas. The domain 155 can correspond to at least one or more rules on taxation of employees of one or more enterprises within one or more geographical areas of the plurality of geographical areas. For example, the domain 155 can correspond to at least one or more laws or one or more rules on wages for employees of one or more enterprises within one or more geographical areas of the plurality of geographical areas. For instance, the domain 155 can correspond to one or more rules on benefits for employees of one or more enterprises within one or more geographical areas of the plurality of geographical areas.

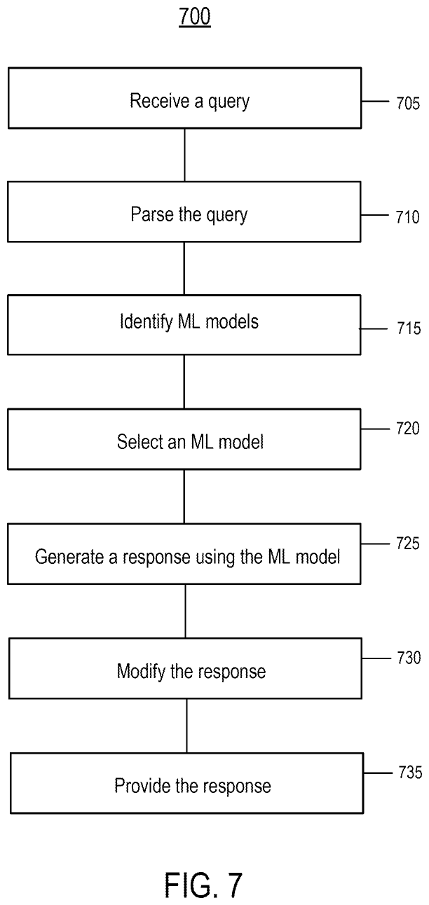

FIG. 7 illustrates a flow diagram of a method 700 for using an ML based multi-model architecture to provide responses to user queries on topics within a particular domain, such as a domain of HR services of an enterprise. The method 700 can be performed by one or more systems or components depicted in FIGS. 1-5, including, for example, a data processing system 130 of FIG. 1 implemented on processors 210 and memory or storage (e.g., 215, 220 or 225) of a computing system 200. At a high level, method 700 can include ACTS 705-735. At ACT 705, the method can receive a query. At ACT 710, the method can parse the query. At ACT 715, the method can identify ML models. At ACT 720, the method can select an ML model. At ACT 725, the method can generate a response using the ML model. At ACT 730, the method can modify the generated response. At ACT 735, the method can provide the response.

At ACT 705, the method can receive a query. The method can include one or more processors coupled with memory receiving a query on a topic. The query can be received from a client device, via a network. The query can include a question on a topic, such as a topic within the domain of human resource services, including for example, employment rules, employee wages, employment laws, taxation of employee or employer income or any other HR related issue. The query can include a topic within any domain, such as enterprise systems or tools, enterprise business practices, enterprise locations or organizational arrangement or any other business related topic or field.

The method can include one or more processing models (e.g., ML models) to condition, modify or clarify the query prior to inputting the query into classifying model to select the generative model to provide the response for the query, or condition or modify the response provided to the query. For example, the one or more processors can generate an output from a model (e.g., a processing model or a third model) trained using at least the plurality of texts on queries to produce a plurality of outputs indicative of the plurality of topics corresponding to a plurality of queries of users. A first portion of the query from a client device can be input into the third model to provide the output paraphrasing or clarifying the query, prior to using the query to identify the generative model to use for generating the response. The output of the third model can be indicative of the topic corresponding to a particular domain of a particular generative model to be selected. A processing model can be utilized to identify the tone of the language used for the query.

At ACT 710, the method can parse the query to identify the portions of the query. The method can include the one or more processors executing or utilizing a parser of the DPS to identify a first portion of the query indicative of the domain to which the query pertains. The method can include the parser of the DPS identifying a second portion of the query indicative of the topic of the domain to which the first portion of the query corresponds. The method can identify a third portion of the query corresponding to, or indicative of, a tone of the user which can be used for a processing model to identify the tone or type of language utilized.

The method can include the data processing system or its parser function splitting the parsed portions of the query into one or more parts. For instance, the method can split the query into a first portion of the query pertaining or corresponding to the domain of the query and a second portion pertaining or corresponding to a topic of the domain. The method can include the data processing system splitting the query into a third portion corresponding to a geographical location for the query and a fourth portion corresponding to a keyword, such as a keyword indicative of a tone or a particular user (e.g., employee of an enterprise), a particular office of the enterprise in a particular location or a region, or a particular rule, law or regulation to enquire about.

At ACT 715, the method can identify ML models. The method can include the one or more processors identifying a plurality of ML models for a plurality of domains. The plurality of ML models can include generative models, including for example LLM or NLP GPT models. The ML models can include transformer based models trained using at least a plurality of texts. Each of the ML models can be trained on a respective domain of the plurality of domains covered by the plurality of ML models. For instance, each generative ML model can cover a corresponding domain including a plurality of topics. Each respective domain of the plurality of domains can cover, for example, a plurality of topics on HR services or a payroll (e.g., payroll or HR laws or rules) for one or more geographic areas. Each geographic area can include one or more regions (e.g., international regions, such as NAFTA states or EU), countries (e.g., US or Germany), states (e.g., Tennessee or Massachusetts), districts or counties or cities or towns.

Topics can include any detailed or specific issues within a particular domain, such as employee wages, taxation, employment rules or laws, employee benefits, or any other HR related field or domains. For example, a domain of a particular ML model can include or correspond to at least one of one or more rules for one or more employees of one or more enterprises in one or more geographical areas of the plurality of geographical areas. For example, a domain of a particular ML model can include or correspond to at least one or more rules on taxation of employees of one or more enterprises within one or more geographical areas of the plurality of geographical areas. For example, a domain of a particular ML model can include or correspond to at least one or more laws or one or more rules on wages for employees of one or more enterprises within one or more geographical areas of the plurality of geographical areas.

At ACT 720, the method can select an ML model. The method can include a classification ML model for selecting a particular generative ML model from a plurality of ML models trained to respond to queries on a plurality of topics in a plurality of domains. The method can include the one or more processors selecting, using at least a first portion of the query input into a first ML model (e.g., classification model) trained to classify the plurality of the ML models according to the topics of the plurality of domains, a first ML model (e.g., generative model) of the plurality of ML models (e.g., plurality of generative models). The first (e.g., generative) ML model can be trained on a domain of the plurality of domains associated with the topic of the query. For example, the selected first ML model can be trained on a domain of topics that include the topic that most closely resembles or corresponds to at least a portion of the query received at ACT 705.

The method can include the one or more processors selecting the first model using at least the first portion of the query input into the classification machine learning (ML) model (e.g., the classification model). The first portion of the query can be indicative of the topic of the domain. For instance, the first portion of the query can include the text indicative of the issue covered by the specific topic within the domain of the first ML model. The first portion of the query can include one or more key words from the user inquiry, such as words indicative of the specific domain. For instance, the query can include the words “minimum wage,” which can be sufficiently indicative of a minimum wage topic of the wage domain of a generative model on wages.

The method can include the one or more processors selecting, using at least the output of a processing model (e.g., the third model at ACT 705) input into the classification ML model, the first ML model. For example, the method can include identifying the first ML model (e.g., the generative model suitable for addressing the user inquiry) based at least on the output of a processing model receiving a user query to provide the output describing the user query with an increased clarity or using alternative phrasing.

The method can include the one or more processors selecting, using at least the first portion of the query and the classification ML model, a second ML model of the plurality of ML models corresponding to a second domain associated with the topic. The second ML model can include, for example, a second generative model for providing a second response to the query. The second generative model can cover a second domain that can include a second topic closely related to (e.g., scoring above a threshold in a similarity search with) the query. The second ML model can be used for providing the second response to the query. The second response can be generated by the second generative ML model as an alternative response to the first response generated by the first generative ML model.

At ACT 725, the method can generate a response using the ML model. The method can include the one or more processors generating a response to the query using at least a second portion of the query input into the first ML model. The second portion of the query can correspond to, or indicate a topic of a domain. The second portion can correspond to a geographic area of the one or more geographic areas and the first ML model. The response can be generated as an output of the first ML model, responsive to the second portion of the query input into the first ML model. For example, a second portion of the query can indicate a particular topic corresponding to a particular payroll service for an employee of an enterprise in a geographic area. For example, the second portion of the query can indicate key words for providing the response to the query, such as details corresponding to the question (e.g., a particular employee benefit of interest, a particular type of wage inquired about or a particular type of employment sought).

The method can include the one or more processors generating the response to the query using at least the second portion of the query input into the first ML model. The second portion of the query can be indicative of a particular human resources issue, an issue about a wage, employee benefits, tax issue or a law or regulation concerning a geographic area. The one or more processors can generate the second response to the query based at least on the topic and using at least the second portion of the query input into the second ML model (e.g., the second generative model selected to generate the second response to the query).

At ACT 730, the method can modify the generated response. The method can include the one or more processors modifying the response generated at ACT 725 utilizing one or more processing ML models. For example, a processing model utilized to identify a tone of the query which can be used to modify or adjust the response to the query generated by the one or more generative ML models (e.g., the second model) in order to accommodate the tone. For instance, if a tone of the language corresponds to anger, frustration or impatience of a user, the response can be modified to add explanation or express understanding for the frustration. For instance, a processing model can summarize the response to provide a shortened version of the response to the user. For instance, the processing model can provide a ranking for a plurality of responses provided by a plurality of generative models for the single query or providing a confidence score for each of the one or more responses.

At ACT 735, the method can provide the response. The method can include the one or more processors providing the response for display. The provided response can include the response as generated by the generative model at ACT 725. The provided response can include a modified response, such as a response modified at ACT 730. The response can be provided for display on a user interface of the client device. The response can be provided by the data processing system, via a network. The response can be provided following updating, correcting or adjusting of the response by the one or more processing models.

For example, the one or more processors can identify, based at least on the query input into a fourth ML model (e.g., a processing model) trained using a textual content corresponding to a plurality of tones, a tone of a text of the query. For example, the processing model can determine that the tone of the user entering the query is anxious or irritated. The one or more processors can update the response according to the tone, such as by rewriting the response in a more soothing or understanding tone. For example, the one or more processors can update, based at least on the tone of the text and the response input into a fifth ML model (e.g., processing model) trained on a plurality of responses for the plurality of tones, the response according to the tone. The fifth model can include a model trained to rewrite the response to respond to the tone identified by the fourth ML model. The method can include the one or more processors providing the response updated by the fifth ML model for display on the client device.

The method can include the one or more processors generating a first score corresponding to a relation between the query and the domain and a second score corresponding to a second relation between the query and the second domain. The first score and the second score can include a confidence score indicative of the level of confidence in the respective responses provided. For instance, the first score can correspond to a confidence score of the first response and the second score can correspond to a confidence score of the second response. The method can include ranking, by the one or more processors, the first response and the second response according to the score. The method can include providing, by the one or more processors, the response for display responsive to the rank of the response.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be a cloud storage product or service, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses.

Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computer device”, “component” or “data processing system” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, a computer system 200 described in FIG. 2 can be used in conjunction with, instead of, or together with system 100 or its system components, and vice versa. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
one or more processors coupled with memory to:
receive a query on a topic;
identify a plurality of machine learning (ML) models for a plurality of domains, each of the plurality of ML models trained using at least a plurality of texts on a respective domain of the plurality of domains, each respective domain of the plurality of domains covers a plurality of topics;
identify a classification ML model trained to classify the plurality of ML models according to the plurality of topics of the plurality of domains;
select a first ML model of the plurality of ML models trained on the domain associated with the topic using at least a first portion of the query corresponding to a domain of the plurality of domains input into the classification ML model;
generate, using at least a second portion of the query corresponding to a topic of the domain input into the first ML model, a response to the query; and
provide, for display, the response.

2. The system of claim 1, comprising the one or more processors to:
parse the query into the first portion indicative of the domain and the second portion indicative of the topic;
select the second model using at least the first portion of the query input into the classification ML model, the first portion indicative of the domain of payroll services to employees of an enterprise; and
generate the response to the query using at least the second portion of the query indicative of the topic corresponding to a payroll service of the payroll services within a geographic area.

3. The system of claim 1, comprising the one or more processors to:
generate, using at least the first portion of the query input into a processing ML model trained using at least the plurality of texts on queries to produce a plurality of outputs indicative of the plurality of topics concerning employees of one or more enterprises, the output indicative of the topic; and
select the first ML model using at least the output of the processing ML model as an input into the classification ML model.

4. The system of claim 1, comprising the one or more processors to:
identify, based at least on the query input into a first processing ML model trained using a textual content corresponding to a plurality of tones, a tone of a text of the query;
update, based at least on the tone of the text and the response input into a second processing ML model trained on a plurality of responses for the plurality of tones, the response according to the tone; and
provide, for display, the response updated by the second processing ML model.

5. The system of claim 1, comprising the one or more processors to:
select, using at least the first portion of the query and the classification ML model, a second ML model of the plurality of ML models corresponding to a second domain associated with the topic; and
generate, using at least the second portion of the query input into the second ML model, a second response to the query based at least on the topic.

6. The system of claim 5, comprising the one or more processors to:
generate a first score corresponding to a relation between the query and the domain and a second score corresponding to a second relation between the query and the second domain;
rank the response and the second response according to the first score and the second score; and
provide the response for display responsive to the rank of the response.

7. The system of claim 1, wherein the domain of the plurality of domains corresponds to a rule for an employee of an enterprise in one or more geographical areas of a plurality of geographical areas and the topic corresponds to a geographical area of the one or more geographical areas.

8. The system of claim 1, wherein the domain of the plurality of domains corresponds to at least one or more rules on taxation of employees of one or more enterprises within one or more geographical areas.

9. The system of claim 1, wherein the domain of the plurality of domains corresponds to at least one or more laws or one or more rules on wages for employees of one or more enterprises within one or more geographical areas.

10. The system of claim 1, wherein the domain of the plurality of domains corresponds to at least one or more rules on benefits for employees of one or more enterprises within one or more geographical areas.

11. A method, comprising:
receiving, by one or more processors coupled with memory, a query on a topic;
identifying, by the one or more processors, a plurality of machine learning (ML) models for a plurality of domains, each of the plurality of ML models trained using at least a plurality of texts on a respective domain of the plurality of domains, each respective domain of the plurality of domains covering a plurality of topics;
identify, by the one or more processors, a classification machine learning (ML) model trained to classify the plurality of ML models according to the plurality of topics of the plurality of domains;
selecting, by the one or more processors, a first ML model of the plurality of ML models trained on a domain of the plurality of domains associated with the topic of the query using at least a first portion of the query corresponding to a domain of the plurality of domains input into the classification ML model;
generating, by the one or more processors, using at least a second portion of the query corresponding to a topic of the domain input into the first ML model, a response to the query; and
providing, by the one or more processors, the response for display.

12. The method of claim 11, comprising:
parsing, by the one or more processors, the query into the first portion indicative of the domain and the second portion indicative of the topic;
selecting, by the one or more processors, the second model using at least the first portion of the query input into the first machine learning (ML) model, the first portion indicative of the domain of payroll services to employees of an enterprise; and
generating, by the one or more processors, the response to the query indicative of the topic corresponding to a payroll service of the payroll services within a geographic area.

13. The method of claim 11, comprising:
generating, by the one or more processors, using at least the first portion of the query input into a processing ML model trained using at least the plurality of texts on queries to produce a plurality of outputs indicative of the plurality of topics concerning employees of one or more enterprises; and
selecting, by the one or more processors, the first ML model using at least the output of the processing ML model as an input into the classification ML model.

14. The method of claim 11, comprising:
identifying, by the one or more processors, based at least on the query input into a first processing ML model trained using a textual content corresponding to a plurality of tones, a tone of a text of the query;
updating, by the one or more processors, based at least on the tone of the text and the response input into a second processing ML model trained on a plurality of responses for the plurality of tones, the response according to the tone; and
providing, by the one or more processors, the response updated by the second processing ML model for display.

15. The method of claim 11, comprising:
selecting, by the one or more processors, using at least the first portion of the query and the classification ML model, a second ML model of the plurality of ML models corresponding to a second domain associated with the topic; and
generating, by the one or more processors, using at least the second portion of the query input into the second ML model, a second response to the query based at least on the topic.

16. The method of claim 15, comprising:
generating, by the one or more processors, a first score corresponding to a relation between the query and the domain and a second score corresponding to a second relation between the query and the second domain;
ranking, by the one or more processors, the response and the second response according to the first score and the second score; and
providing, by the one or more processors, the response for display responsive to the rank of the response.

17. The method of claim 11, wherein the domain of the plurality of domains corresponds to a rule for an employee of an enterprise in one or more geographical areas and the topic corresponds to a geographical area of the one or more geographical areas.

18. The method of claim 11, wherein the domain of the plurality of domains corresponds to at least one or more rules on taxation of employees of one or more enterprises within one or more geographical areas.

19. The method of claim 11, wherein the domain of the plurality of domains corresponds to at least one or more laws or one or more rules on wages for employees of one or more enterprises within one or more geographical areas.

20. A non-transitory computer-readable media having processor readable instructions, such that, when executed, the processor readable instructions cause at least one processor to:
receive, from a device, a query on a topic;
parse the query into a first portion indicative of a domain of the plurality of domains and the second portion indicative of a topic of the domain corresponding to a geographic area of one or more geographic areas;
identify a plurality of machine learning (ML) models for the plurality of domains, each of the plurality of ML models trained using at least a plurality of texts on a respective domain of the plurality of domains, each respective domain of the plurality of domains covers a plurality of topics corresponding to one or more geographic areas;
identify a classification model trained to classify the plurality of ML models according to the plurality of topics of the plurality of domains;
select a first ML model of the plurality of ML models trained on the domain of the plurality of domains associated with the topic of the query using at least a first portion of the query input into the classification model;
generate, using at least the second portion of the query input into the first ML model, a response to the query; and
send the response to the device.
